(19) United States
(12) Patent Application Publication
(10) Pub. No.: US 2004/0133918 A1
(43) Pub. Date: Jul. 8, 2004

(54) High-level menu display of purchased content using existing bandwidth

(76) Inventor: Daniel Danker, Sunnyvale, CA (US)

Correspondence Address: LEE & HAYES PLLC, 421 W RIVERSIDE AVENUE SUITE 500, SPOKANE, WA, 99201

(21) Appl. No.: 10/336,448

(22) Filed: Jan. 3, 2003

(51) Int. Cl. H04N 7/173

(52) U.S. Cl. 725/100; 725/87; 725/104

(57) ABSTRACT

Systems and methods are described for displaying purchased content information in a high-level menu display of a server-client broadcast system. Purchased content information is stored locally and is changed according to viewing parameters. The menu display reflects the current purchased content information. When the client accesses the server for other purposes, purchased content information is exchanged between the client and the server. Accordingly, only existing bandwidth is utilized and no additional load is placed on the system as a result of maintaining purchased content information in a high-level menu.

### TECHNICAL FIELD

The systems and methods described herein relate to broadcasting multimedia content available for purchase. More particularly, the described systems and methods relate to displaying purchased multimedia content in a high-level menu of a broadcast system without requiring additional network bandwidth than that normally used by the broadcast system.

### BACKGROUND

Recent technological innovations have made it relatively easy for a consumer of multimedia broadcast (audio and/or video) content to purchase multimedia events, such as pay-per-view (PPV) events (movies, sporting events, etc.) and video-on-demand (VOD) events (movies, television programs, etc.). The use of content-for-purchase, such as PPV and VOD, has increased significantly in the last few years.

However, once a user has purchased one or more content events, it is not so easy for the user to determine the availability of the purchased content. In other words, the user may not remember details such as the date, time, channel, etc. of purchased content events and may need to access that information via a menu system associated with the broadcast content. But this information is typically found in lower-level menu pages to which the user must navigate before the user can see the information.

Present broadcast systems place static information on higher-level menu displays that are displayed more frequently than lower-level menu displays because to display up-to-date purchased content information, a client in a broadcast system must access a server in the broadcast system to obtain the information. However, given the enormous amount of data transmitted between the client and server, a premium is placed on available bandwidth between the server and multiple clients. As a result, it is impractical—using current methods—to display purchased content information on a top-level (or high-level) menu display.

### SUMMARY

Systems and methods are described for displaying purchased multimedia content information on a high-level menu display without having to utilize more broadcast bandwidth that is normally utilized. In one implementation described herein, the purchased content information is displayed on a top-level, or “home,” menu display that is easily accessed—typically through a single remote button.

The systems and methods described herein display purchased content events on a top-level menu and, in at least one implementation, the expiration time and date of video-on-demand (VOD) events. The purchased content information is stored locally, such as on a set-top box (STB). Each time the client makes a request from the server, the purchased content information is retrieved from the server. As a result, the set-top box retains enough information locally to know whether a purchased content item should be displayed without having to make a special request to the server each time the menu display page is displayed.

In one implementation, the data stored in a set-top box is utilized to warn a user if the time required to view a VOD event (or the remainder of the event) is later than an expiration time for the event. This provides the user with the opportunity to skip some of the content to view the end of the event, if that is desirable.

### BRIEF DESCRIPTION OF THE DRAWINGS

The same numbers are used throughout the drawings to reference like features and components.

FIG. 1 illustrates an exemplary broadcast system in which the described systems and methods can be implemented.

FIG. 2 illustrates a television-based system that includes an exemplary client device according to the described systems and methods.

FIG. 3a is an illustration a top-level menu that displays purchased multimedia video-on-demand (VOD) content.

FIG. 3b is an illustration of a top-level menu that displays purchased multimedia pay-per-view (PPV) content.

FIG. 4 is a flow diagram depicting an exemplary methodological implementation of displaying purchased content information on a high-level menu display using existing bandwidth.

FIG. 5 is a flow diagram depicting an exemplary methodological implementation of a portion of the function of a menu application.

FIG. 6 illustrates an exemplary broadcast video distribution architecture in which the described techniques can be implemented.

FIG. 7 further illustrates components of the exemplary broadcast video distribution architecture shown in FIG. 6.

### DETAILED DESCRIPTION

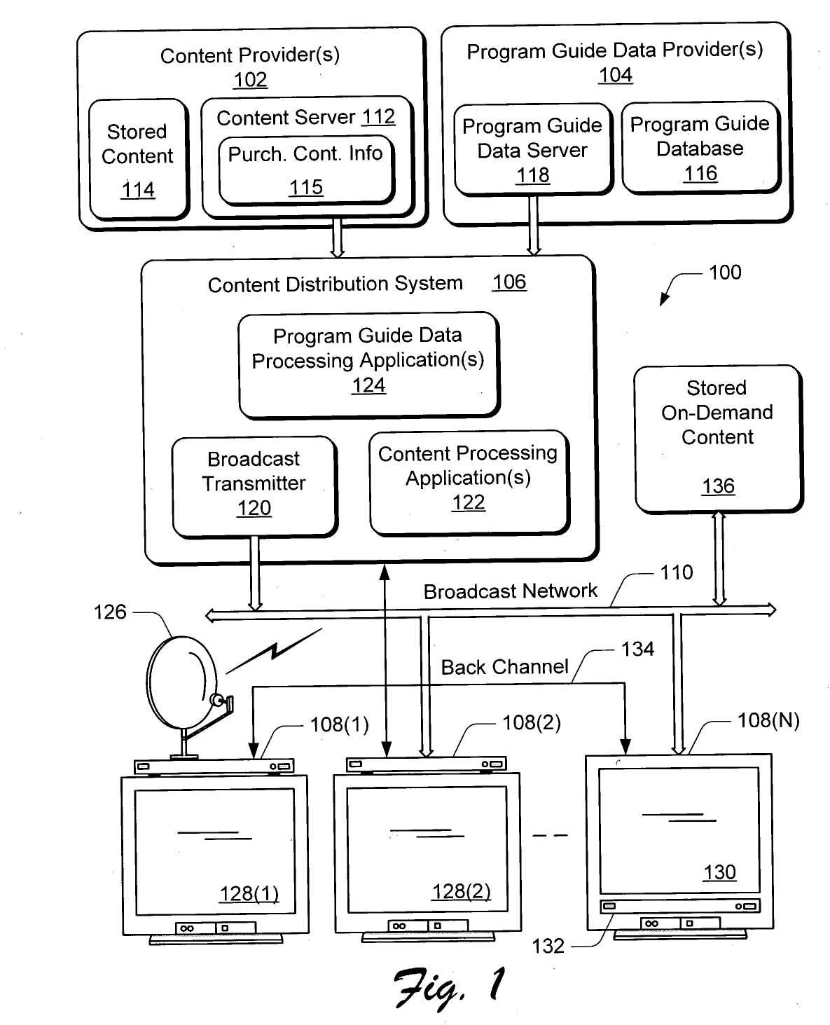

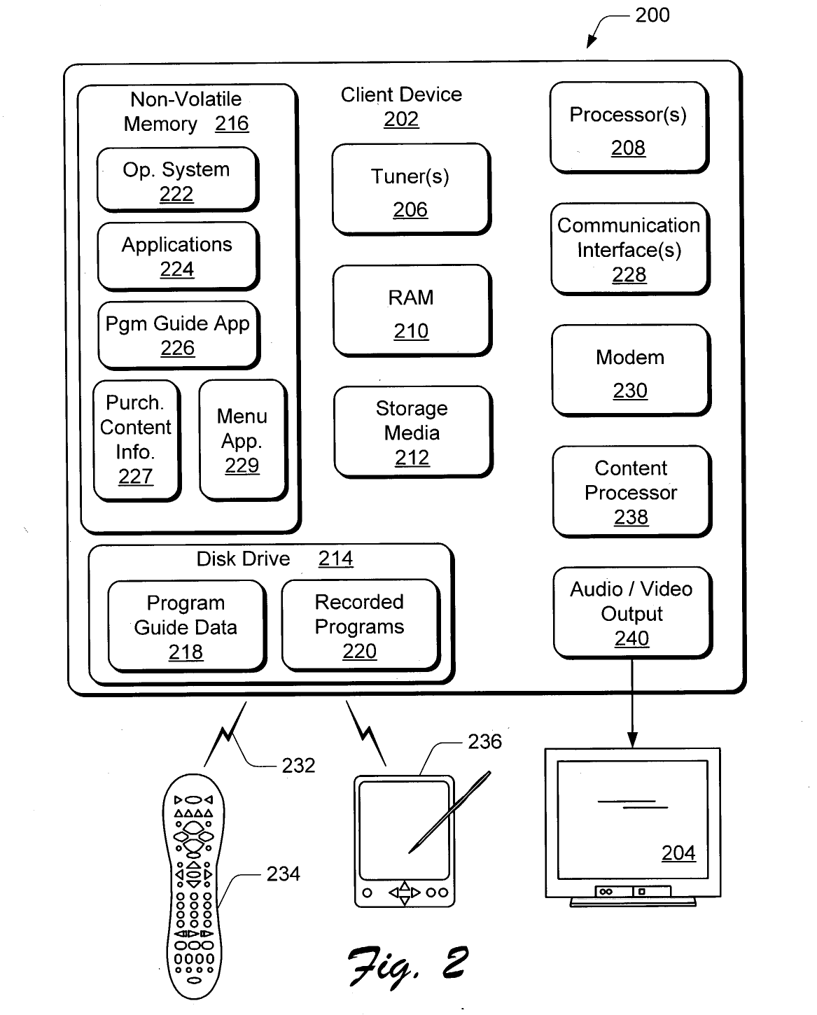

Systems and methods for displaying purchased content information on a high-level or top-level menu display using present bandwidth are described below. An exemplary broadcast system architecture and an exemplary client device in a television-based system are initially described with reference to FIG. 1 and FIG. 2, respectively, to first describe an operating environment on which the described techniques may be implemented.

Exemplary Broadcast System

FIG. 1 illustrates an exemplary system 100 in which a high-level menu display of purchased content can be implemented without requiring additional bandwidth than that already utilized by the system 100. System 100 facilitates distribution of content and program guide data to multiple viewers. The system 100 includes one or more content providers 102, one or more program guide data providers 104, a content distribution system 106, and multiple client devices 50.108(1), 108(2), . . . , 108(N) coupled to the content distribution system 106 via a broadcast network 110.

A content provider 102 can be implemented as a satellite operator, a network television operator, a cable operator, and the like. A content provider 102 includes a content server 112 to control distribution of stored content 114, such as movies, television programs, commercials, music, and similar audio, video, and/or image content from content provider 102 to the content distribution system 106. The stored content 114 may also include content available for purchased, such as pay-per-view and/or video-on-demand content. Additionally, content server 112 controls distribution of live content (e.g., content that was not previously stored, such as live feeds) and/or content stored at other locations to the content distribution system 106. The content distribution system 106 is representative of a headend service and/or program data center that provides content and program guide data to multiple subscribers (e.g., client devices 108).

The content server 112 also stores purchased content information 115 that identifies client devices 108 and associates them with purchased content selected by a user. The purchased content information 115 includes, but is not limited to, a program title, an asset identifier, a program expiration time, and a program expiration date associated with each item of purchased content. In one extended implementation, the purchased content information 115 also includes more detailed information, such as a program description, a program run time, a program rating, program actors' names, a producer's name, a director's name, etc. Any combination of the above information items as well as other items not listed may be stored in any particular configuration of the purchased content information 115.

A program guide data provider 304 includes a program guide database 116 and a program guide data server 118. The program guide database 116 stores program guide data that is used to generate an electronic or interactive program guide (or “program guide”). Program guide data can include a program title, program broadcast day(s) to identify which days of the week the program will be broadcast, program start times(s) to identify a time that the program will be broadcast on the particular day or days of the week, and a program category.

A program guide data provider 104 transmits program guide data to the program guide data server 118, which processes the program guide data prior to distribution to generate a published version of the program guide data which can contain programming information for all broadcast channels and on-demand content listings for one or more days. Content distribution system 106 includes a broadcast transmitter 120, one or more content processing applications 122, and one or more program guide data processing applications 124. Broadcast transmitter 120 broadcasts signals, such as cable television signals, across broadcast network 110. Broadcast network 110 can include a cable television network, RF, microwave, satellite, and/or data network, such as the Internet, and may also include wired or wireless transmission media using any broadcast format or broadcast protocol. Additionally, broadcast network 110 can be any type of network, using any type of network topology and any network communication protocol, and can be represented or otherwise implemented as a combination of two or more networks.

A content processing application 122 processes the content received from a content provider 102 prior to transmitting the content across broadcast network 110. Similarly, a program guide data processing application 124 processes the program guide data received from a program guide data provider 104 prior to transmitting the program guide data across broadcast network 110. A particular content processing application 122 may encode, or otherwise process, the received content into a format that is understood by the multiple client devices 108 which are coupled to broadcast network 110. Although FIG. 1 shows a single content provider 102, a single program guide data provider 104, and a single content distribution system 106, exemplary system 100 can include any number of content providers and/or program guide data providers coupled to any number of content distribution systems.

Client devices 108 can be implemented in a number of ways. For example, a client device 108(1) receives broadcast content from a satellite-based transmitter via a satellite dish 126. Client device 108(1) is also referred to as a set-top box or a satellite receiving device. Client device 108(1) is coupled to a television 128(1) for presenting the content received by the client device (e.g., audio data, video data, and image data), as well as a graphical user interface. A particular client device 108 can be coupled to any number of televisions 128 and/or similar devices that can be implemented to display or otherwise render content. Similarly, any number of client devices 108 can be coupled to a single television 128.

Client device 108(2) is also coupled to receive broadcast content from broadcast network 110 and provide the received content to associated television 128(2). Client device 108(N) is an example of a combination television 130 and integrated set-top box 132. In this example, the various components and functionality of the set-top box are integrated into the television, rather than using two separate devices. The set-top box integrated into the television can receive broadcast signals via a satellite dish (similar to satellite dish 126) and/or via broadcast network 110. In alternate implementations, client devices 108 may receive broadcast signals via the Internet or any other broadcast medium, such as back channel 134 which can be implemented using a protocol such as an Internet protocol (IP), UDP protocol, etc. The back channel 134 may also be implemented with various types of delivery mechanisms, such as an RF back channel (i.e., cable), a modem, or the like. The back channel 134 provides an alternate communication link between each of the client devices 108 and the content distribution system 106. In some instances, the back channel 134 may also provide communication between the client devices 108. However, in a typical implementation, one client device 108 must usually communicate with another client device through a headend service.

The exemplary system 100 also includes stored on-demand content 136, such as Video-On-Demand (VOD) and/or Pay-Per-View (PPV) movie content (collectively, “purchased content”). The stored on-demand content 136 can be viewed with a television 128 via a client device 108 through an onscreen movie guide, for example, and a viewer can enter instructions to stream a particular movie, or other stored content, to a corresponding client device 108.

Exemplary Client Device in a Television-Based System

FIG. 2 illustrates a television-based system 200 that includes an exemplary client device 202 that includes components to implement the systems and methods described herein. System 200 also includes a display device 204 to display content received by the client device 202. The client device 202 can be implemented as a set-top box, a satellite receiver, a TV recorder with a hard disk, a digital video recorder (DVR) and playback system, a personal video recorder (PVR) and playback system, a game console, an information appliance, and as any number of similar embodiments.

Client device 202 includes one or more tuners 206 which are representative of one or more in-band tuners that tune to various frequencies or channels to receive television signals, as well as an out-of-band tuner that tunes to the broadcast channel over which program data is broadcast to client device 202. Client device 202 also includes one or more processors 208 (e.g., any of microprocessors, controllers, and the like), which process various instructions to control the operation of client device 202 and to communicate with other electronic and computing devices.

Client device 202 can be implemented with one or more memory components, examples of which include a random access memory (RAM) 210, mass storage media 212, a disk drive 214, and a non-volatile memory 216 (e.g., ROM, Flash, EPROM, EEPROM, etc.). It is noted that any further reference made to storing one or more elements in the non-volatile memory 216 encompasses an included reference to one or more other types of memory. Disk drive 214 can include any type of magnetic or optical storage device, such as a hard disk drive, a magnetic tape, a rewriteable compact disc, a DVD, and the like. The one or more memory components store various information and/or data such as received content, program guide data 218, recorded programs 220, configuration information for client device 202, and/or graphical user interface information. Alternative implementations of client device 202 can include a range of processing and memory capabilities, and may include any number of differing memory components than those illustrated in FIG. 2. For example, full-resource clients can be implemented with substantial memory and processing resources, whereas low-resource clients may have limited processing and memory capabilities.

An operating system 222 and one or more application programs 224 can be stored in non-volatile memory 216 and executed on processor(s) 208 to provide a runtime environment. A runtime environment facilitates extensibility of client device 202 by allowing various interfaces to be defined that, in turn, allow application programs 224 to interact with client device 202. The application programs 224 can include a browser to browse the Web (e.g., “World Wide Web”), an email program to facilitate electronic mail, and/or any number of other application programs.

A program guide application 226 that executes on processor(s) 208 is also stored in non-volatile memory 216 and is implemented to process the program guide data 218 for display. Program guide application 226 generates the program guides that enable a viewer to navigate through an onscreen display and locate broadcast programs, recorded programs, video-on-demand movies, interactive game selections, and other media access information or content of interest to the viewer. With program guide application 226, the television viewer can look at schedules of current and future programming, set reminders for upcoming programs, and/or enter instructions to record one or more programs.

Purchased content information 227 is also stored in the non-volatile memory 216 of the client device 202. The purchased content information 227 is described in greater detail, below, and includes information about content that has been purchased by a user using the client device 202. The purchased content information 227 may include data such as content title, asset identification number, date, start time, expiration time and date, run time, number of viewings allowed, and the like. It is noted that the preceding list is exemplary and not exhaustive.

A menu application 229 is included in the non-volatile memory 216 and is executed to display a system of menus configured to allow users to navigate through a system to locate programs, view/change settings, access help, etc. In the present example, the menu application 229 will be discussed in relation to the specific task of displaying a top-level or “home” menu display that displays, inter alia, all or part of the purchased content information 227. The menu application 229 will be discussed in greater detail below.

Client device 202 further includes one or more communication interfaces 228 and a PSTN, DSL, cable, or other type of modem 230. A communication interface 228 can be implemented as a serial and/or parallel interface, as a wireless interface, and/or as any other type of network interface. A wireless interface enables client device 202 to receive control input commands 232 and other information from a user-operated input device, such as from a remote control device 234 or from another infrared (IR), 802.11, Bluetooth, or similar RF input device. Input devices can include a wireless keyboard or another handheld input device 236 such as a personal digital assistant (PDA), handheld computer, wireless phone, or the like. A network interface and a serial and/or parallel interface enables client device 202 to interact and communicate with other electronic and computing devices via various communication links. Modem 230 facilitates client device 202 communication with other electronic and computing devices via a conventional telephone line, a DSL connection, cable, and/or other type of connection.

Client device 202 also includes a content processor 238 which can include a video decoder and/or additional processors to receive, process, and decode broadcast video signals and program data, such as NTSC, PAL, SECAM, or other television system analog video signals, as well as DVB, ATSC, or other television system digital video signals. For example, content processor 238 can include an MPEG-2 or MPEG-4 (Moving Pictures Experts Group) decoder that decodes MPEG-encoded video content and/or image data. The systems described herein can be implemented for any type of video encoding format as well as for data and/or content streams that are not encoded.

Typically, video content and program data includes video data and corresponding audio data. Content processor 238 generates video and/or display content that is formatted for display on display device 204, and generates decoded audio data that is formatted for presentation by a presentation device, such as one or more speakers (not shown) in display device 204. Content processor 238 can include a display controller (not shown) that processes the video and/or display content to display corresponding images on display device 204. A display controller can include a graphics processor, microcontroller, integrated circuit, and/or similar video-processing component to process the images.

Client device 202 also includes an audio and/or video output 240 that provides the audio, video, and/or display signals to television 204 or to other devices that process and/or display, or otherwise render, the audio and video data. Video signals and audio signals can be communicated from client device 202 to television 204 via an RF (radio frequency) link, S-video link, composite video link, component video link, or other similar communication link.

Although shown separately, some of the components of client device 202 may be implemented in an application specific integrated circuit (ASIC). Additionally, a system bus (not shown) typically connects the various components within client device 202. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Exemplary High-Level Menu Display

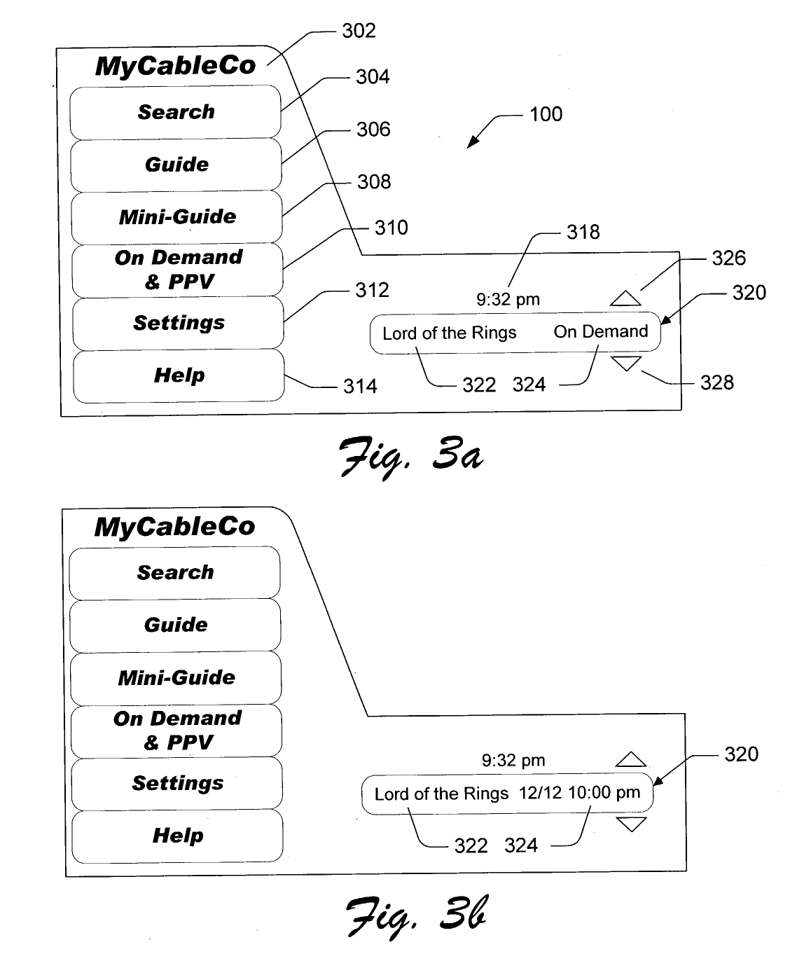

FIG. 3a depicts an exemplary top-level menu display 300 in accordance with the systems and methods described herein. Although a top-level menu display 300 is shown, it is noted that a high-level display menu that is only one level below the top-level menu display 300 may also be implemented within the scope of the present description. The top-level menu display 300 shown is a “home” menu that is generally accessible by actuation of a single button on a remote control device. The top-level menu display 300 includes a heading 302 (“MyCableCo”) that can be used to identify the broadcast system with which the top-level menu display 300 is associated. Several activation bars 304-314 are included on the top-level menu display 300 that, when actuated, access a lower-level menu display (not shown) or initiate an application. The activation bars 304-314 shown in FIG. 3 include a “Search” activation bar 314 that is used to search program listings, a “Guide” activation bar 316 that is used to display a programming guide, and a “Mini-Guide” activation bar 318 that is used to display an abbreviated version of the programming guide. The activation bars 304-314 also include an “On Demand & PPV” activation bar 310 that is actuated to display content events that are available for purchase, a “Settings” activation bar 312 that is used to access system settings and/or controls, and a “Help” activation bar 314 that, when activated, accesses a help program.

The top-level menu display 300 also includes a clock 318 that displays current time and a purchased content display box 320. The purchased content display box 320 includes a purchased content title display 322 and a viewing parameters display 324. The viewing parameters display 324 shows one or more viewing parameters associated with the content identified in the purchased content title display 322.

For instance, in the present example, the purchased content title display 322 identifies “Lord of the Rings” as a purchased event. For that event, the viewing parameters display 324 indicates that it is an “On Demand” event, meaning that the user may view it at any time. Other implementations may also display an expiration time and date, a number of viewings allowed, or other viewing parameters in the viewing parameters display 324.

A scroll up actuator 326 and a scroll down actuator 328 are also displayed on the top-level menu display 300. In the present example, the purchased content display box 320 is configured to show on purchased event at a time. If the user has purchased more than one event, then the scroll up actuator 326 and the scroll down actuator 328 may be used to scroll through the purchased content events. Other scrolling means, such as a scroll bar, may be used in place of the scroll up actuator 326 and the scroll down actuator 328.

FIG. 3b depicts the top-level menu display 300 as shown in FIG. 3a. However, the viewing parameters display 324 of the purchased content display box 320 indicates that “Lord of the Rings” is available on December 12 at 10:00 p.m. In this case, the purchased content is a pay-per-view movie that has a scheduled start time that the user must observe. As previously stated, different and/or additional viewing parameters may be displayed in other implementations.

As previously discussed, the purchased content information 227 (FIG. 2) is stored on the client device 202 (i.e., set-top box), which makes the information 227 readily available to an application program 224 that creates and displays the top-level menu display 300. By having the information in the client device 202, the client device 202 does not have to make a special request to obtain this information. Instead, the information is updated whenever the client device 202 accesses a broadcast server for another task.

Exemplary Methodological Implementations

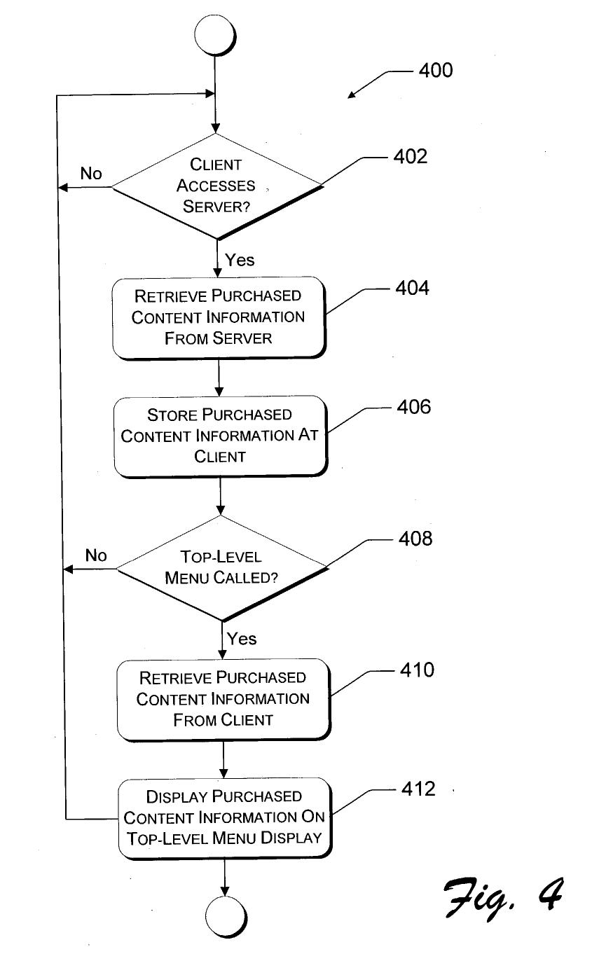

FIG. 4 is a flow diagram 400 depicting an exemplary methodological implementation of a high-level menu display of purchased content using existing bandwidth. The following discussion will make continuing reference to the elements and reference numerals shown in the previous figures (FIGS. 1-3). Particularly, the discussion will focus on a single client device 108 and a single content server 112. However, it is noted that such particularity is for discussion purposes only and is not meant to limit the scope of the discussion to those particular, or to single, devices. Furthermore, the following description could apply to one or more servers other than the content server 112.

At block 402, the menu application 229 monitors client device 108 activity and determines when the client device 108 accesses the content server 112. As long as the client device 108 does not access the server 112, the menu application 229 continues the monitoring (“No” branch, block 402).

When the server 112 is accessed (“Yes” branch, block 402), the menu application 229 retrieves the purchased content information 115 that is stored on the content server 112 at (block 404) and stores the purchased content information (115, FIG. 1; 229, FIG. 2) on the client device 202, FIG. 2 at block 406. This is done each time the client device 202 accesses the content server 112. However, in one implementation, the purchased content information 115 may only be downloaded to the client if the purchased content information 115 has changed since the last time it was downloaded.

It is noted that the purchased content information 115 may also be updated without a request from the menu application. This is the case in the event that the content server is configured to automatically send the purchased content information 115 to the client whenever a different back channel request is made that requires a response from the content server. In such an implementation, a back channel request to the server for the original intended purpose does not become any larger and, therefore, conserves bandwidth.

As long as the top-level menu display 300, FIG. 3 is not called (“No” branch, block 408, the menu application 229 continues the monitoring process from block 402. When a user calls the top-level menu display 300 (“Yes” branch, block 408), then the menu application 229 retrieves the purchased content information 227 from the client device 202 (block 410) and displays the purchased content information 227 in the appropriate location on the top-level menu display 300 (block 412).

The menu application 229 also detects local changes to the purchased content information 227 and stores changes information accordingly in the purchased content information 227. It is noted that for purposes of the present discussion, the menu application 229 is attributed the task of maintaining the purchased content information 227 with local changes. However, another application may be configured to accomplish this task and/or some others that have been described.

An example of when a “local” change occurs is when a time limit on a purchased content program expires. The content server 112 is aware of the expiration and takes care of changes at the server 112. However, the client device 202 doesn't download such a change until the server 112 is accessed. Between the time that the time limit expires and the client device 202 accesses the content server 112, the top-level menu display 300 would still show the expired content program as being available for viewing, when it is not. However, having the local application (menu application 229) detect when a time limit expires and changing the (local) purchased content information allows the top-level menu display 300 to display correct information at all times.

Another example is when a user views a purchased content program and is not allowed to view it again. Normally, if the content server 112 is not updated, the purchased content information 115 will not reflect the viewing until the client device 202 accesses the content server 112. But with the present techniques, the menu application 229 simply updates the (local) purchased content information 227 to reflect that the viewer's privileges—as far as the viewed program is concerned—have expired. The client device 202 does not need to make a special access to the content server 112 to update the information 115 on the server 112 because the information is changed locally. The next time the server 112 is accessed, the (remote) purchased content information 115 is amended to reflect the change.

In some broadcast systems, a user may be able to cancel a purchased program prior to viewing the program. In such a system, a user cancellation comprises a local change that would be reflected immediately on the top-level menu display 300.

When a program is canceled or viewed or the time to access the program has expired, the client device 202 retires the purchased content program from the top-level menu display 300. This may be done immediately upon the event causing the retirement without accessing the content server 112.

In at least one implementation, an allowance is made for a user who switches from watching a purchased content program momentarily to, for example, check the score of a ball game. A time limit is configured into the menu application 229 that, if not surpassed, maintains the user's viewing privileges. For example, if the user changes channels for less than five minutes, the program is still available for viewing by the user and the top-level menu display 300 reflects this.

Such a configuration is especially useful in conjunction with content subscription services. For example, if a user subscribes to a special “James Bond Package” and the episodes are listed in the top-level menu display 300 as being available for viewing until they are viewed, the user can change channels during a viewing without losing the information from the top-level menu display 300.

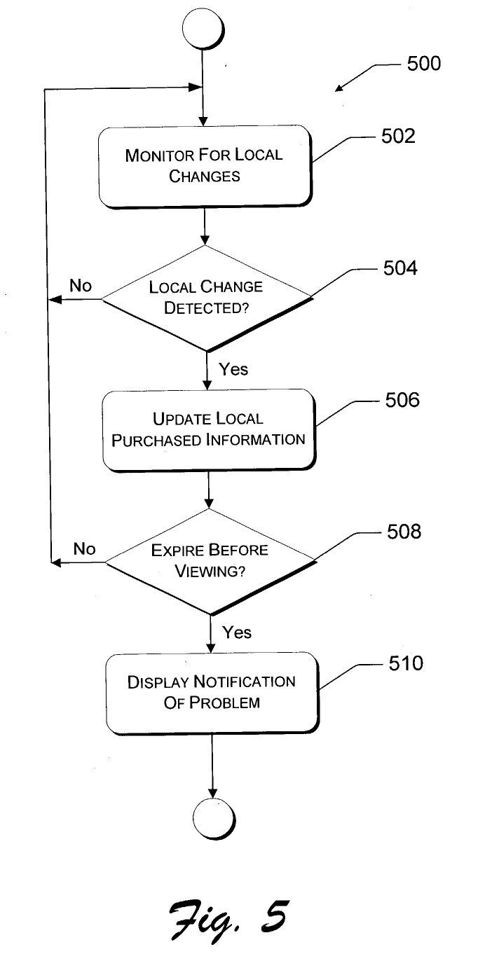

FIG. 5 is a flow diagram 500 that depicts part of the function carried out by the menu application 229. At block 502, the menu application 229 monitors for local changes, such as an expiring time limit, a count of number of times a purchased content program has been viewed, the run time of a presently viewed purchased content program, the current time, etc. As long as no change is detected locally (“No” branch, block 504), then the monitoring process continues at block 502.

When the menu application 229 detects a local change (“Yes” branch, block 504), the menu application 229 updates the purchased content information 227 to reflect that change (block 506). Otherwise, the monitoring process continues at block 502.

In at least one on-demand implementation, the monitoring process includes keeping track of the run time and start time of a currently accessed content program, or an amount of time until the conclusion of the program (“conclusion time). If the menu application 229 determines that a time limit associated with the currently accessed content program will expire before the conclusion time (“Yes” branch, block 508), then a user is notified of that fact (block 510) so that the user may fast-forward through parts of the program to be able to experience the conclusion of the program. Otherwise, the monitoring process continues at block 500.

Exemplary Broadcast Video Distribution Architecture

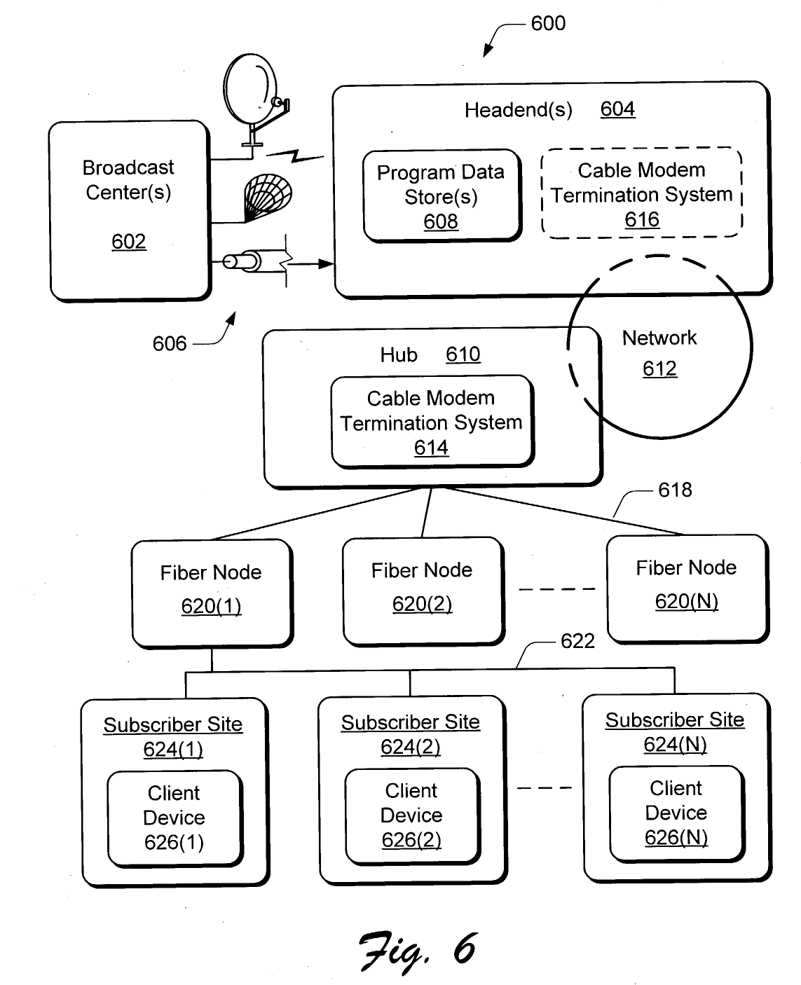

The following description relates to a more detail discussion of an environment in which the present systems and methods may be implemented. In 11 FIG. 6, one or more broadcast centers 602 provide broadcast content to one or more headends 604 via one or more transmission media 606. Each broadcast center 602 and headend 604 interfaces with the various transmission media 606, such as a satellite transmission, radio frequency transmission, cable transmission, and/or via any number of other transmission media. A broadcast center 602 can be implemented as a satellite operator, a network television operator, a cable operator, and the like.

A headend 604 includes one or more program data stores 608 to record the broadcast content that is received via a transmission media 606. The broadcast content can be stored, or otherwise recorded, while the broadcast content is in a compressed format, for example, in order to facilitate the ongoing storage of the content over days, weeks, or even indefinitely. The compression format may comport with a Moving Pictures Expert Group (MPEG) algorithm such as MPEG-2, MPEG-4, and so forth. Other compression technologies may alternatively be employed, such as Microsoft Windows® Media, Advanced Simple Profile (ASP), Cintak, and the like.

A headend 604 and a hub 610 communicate across a network 612 which can be implemented as a fiber ring that may operate with a packet-based protocol, such as Internet protocol (IP), IP over asynchronous transfer mode (ATM), and other protocols. Packets can therefore be communicated between headend 604 and hub 610, which includes a cable modem termination system 614 for terminating communications from downstream cable modems. Alternatively, headend 604 may include a cable modem termination system 616 to terminate the cable modem communications. Although only one hub 610 is illustrated in architecture 600, a headend 604 can distribute broadcast content to multiple hubs 610 via network 612.

Hub 610 distributes the broadcast content over fiber lines 618 to one or more fiber nodes 620(1), 620(2). 620(N). Each fiber node 620 has one or more coaxial lines 622 over which the broadcast content is output, and each coaxial line 622 includes coaxial line drops to multiple subscriber sites 624(1), 624(2), . . . 624(N). Each subscriber site 624 includes one or more client devices 626(1), 626(2), . . . 626(N), respectively. Subscriber sites 624 can be homes, businesses, and the like with each subscriber site 624 including multiple client devices 626 that are each directly or indirectly interfacing with one or more of coaxial lines 622. Client devices 626 may be computers, set-top boxes of varying capabilities, hand-held and/or portable electronic devices, digital televisions, and so forth. Each client device 626 may include an integrated video screen or may be coupled to a video screen.

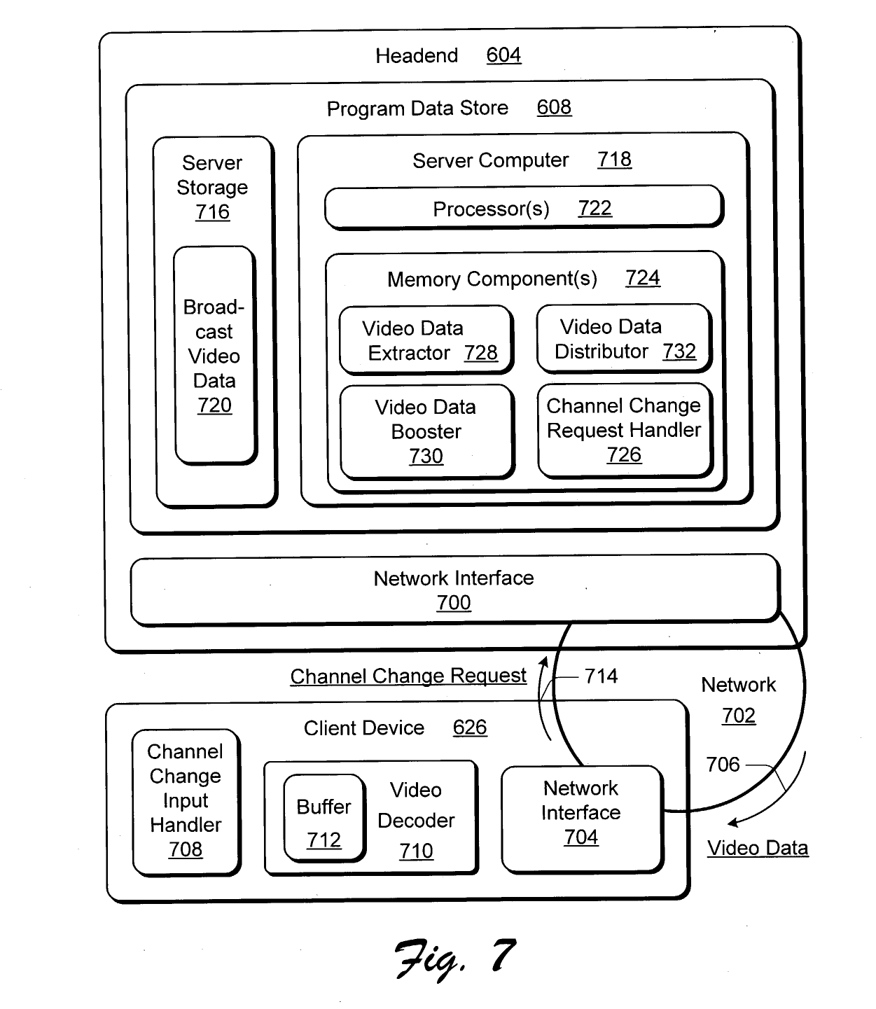

FIG. 7 further illustrates an exemplary headend 604 and an exemplary client device 626 as shown in FIG. 6. Headend 604 includes a network interface 700 to communicate over a network 702, and client device 626 includes a network interface 704 to communicate over the network 702. Network 702 can be any two-way unicast network, such as a unicast network that enables point-to-point Internet protocol (IP) sessions, for example. Alternatively, network 702 can be implemented as a video-on-demand (VOD) type network, as a video over digital subscriber line (DSL)-based network, and the like.

Network 702 may include one or more other nodes that are upstream of client device 626 in addition to headend 604. For example, hub 610 (FIG. 6) and fiber nodes 620 may be located between client device 626 and headend 604 for forwarding and/or routing packets or other communications between the devices. Additionally, network 702 can be implemented as a combination of networks and network interfaces 700 and 704 may vary depending on the architecture of network 702. In an exemplary cable network implementation, network interface 700 includes a cable modem termination system (such as system 616 in FIG. 6) if there is not an intervening cable modem termination system in network 702, and network interface 704 includes a cable modem. Network interface 700 and/or network interface 704 may also include components for interacting with an IP network, a DSL network, and so forth. These components may include a receiver, a transmitter, a transceiver, etc. that are adapted to interact with the appropriate network.

In one exemplary implementation, broadcast content distribution from headend 604 to client device 626 is implemented with a point-to-point IP session that is established between headend 604 and client device 626. Broadcast content, such as video data 706 for a specific channel, is streamed to client device 626 across network 702. Thus, each client device 626 receives its own designated broadcast video data stream according to its corresponding requested channel. Further, each fiber node 620 (FIG. 1), if present, has a different current allocation of a two-way portion of the network that is intended for downstream transmissions to client devices 626.

Client device 626 includes a channel change input handler 708 and a video decoder 710, as well as the network interface 704. Video decoder 710 includes a buffer 712 for storing received broadcast content, such as the video data, prior to decoding. Channel change input handler 708 receives channel change input requests from a user of client device 626. A channel change input request can be received from a remote control, a keyboard, a personal digital assistant (PDA), a touch-sensitive screen, integrated keys, and from any other type of input device.

Channel change input handler 708 can be implemented as executable instructions and/or hardware, software, firmware, or some combination thereof. Channel change input handler 708 constructs a channel change request 714 in packet form that includes an indicator of the requested channel. Channel change request 714 is communicated from channel change input handler 708 to network interface 704 of client device 626 for transmission over network 702.

Network interface 700 of headend 604 receives channel change request 714 via network 702, and provides the channel change request 714 to the program data store 608. Program data store 608 includes server storage 716 and a server computer 718. Server storage 716 includes a storage device (not explicitly shown) that comprises mass memory storage, such as a disk-based storage device. Examples of suitable disk-based storage devices and/or systems include a redundant array of independent/inexpensive disks (RAID), a Fibre Channel storage device, and the like.

Server storage 716 stores broadcast video data 720 that is broadcast from a broadcast center 602 (FIG. 1) to headend 604 in a compressed format. In an exemplary implementation, the compressed format comprises a digital stream in accordance with an MPEG protocol, such as MPEG-4. However, other compression formats may alternatively be used. As the compressed digital stream is received at headend 604, it is stored as broadcast video data 720. Server storage 716 can maintain broadcast video data 720 for multiple channels as it is received over hours, days, weeks, and/or indefinitely.

Server computer 718 enables access to the stored, or otherwise recorded, broadcast video data 720 at server storage 716. Server computer 718 includes one or more processors 722 and one or more memory component(s) 724. Although not shown, server computer 718 may also include other components such as input/output interfaces; a local disk drive; hardware and/or software for encoding, decoding, and otherwise manipulating video data, and so forth. A memory component 724 can be implemented as, or include, a non-volatile memory such as disk drive(s) or flash memory and/or volatile memory such as random access memory (RAM). In an exemplary implementation, a memory component 724 includes processor-executable instructions.

Specifically, a memory component 724 includes the following processor-executable instructions: a channel change request handler 726, a video data extractor 728, a video data booster 730, and a video data distributor 732. The processor-executable instructions of memory component 724 can be executed on a processor 722 to implement functions as described below. In alternative implementations, one or more of channel change request handler 726, video data extractor 728, video data booster 730, and video data distributor 732 may be stored in a memory such that they are hardware encoded for automatic execution and/or for faster execution by a processor 722.

Network interface 700 forwards channel change request 714 to channel change request handler 726 that isolates the requested channel from channel change request 714 and provides the requested channel to video data extractor 728. Video data extractor 728 extracts broadcast video data for the requested channel from broadcast video data 720 of server storage 716. Video data distributor 732 communicates the broadcast video data to network interface 700, which transmits the broadcast video data over network 702 as video data packet(s) 706. Client device 626 receives the video data packet(s) 706 via network 702 at network interface 704.

### CONCLUSION

Although the invention has been described in language specific to structural features and/or methods, it is to be understood that the invention defined in the appended claims is not necessarily limited to the specific features or methods described. Rather, the specific features and methods are disclosed as preferred forms of implementing the claimed invention.

1. A method, comprising:
retrieving purchased content information from a client device, the purchased content information relating to one or more items of purchased content;
displaying one or more viewing parameters taken from the purchased content information in a broadcast system high-level menu display;
updating the purchased content information from a remote purchased content information on a content server when the client accesses the content server for a purpose other than updating the purchased content information.

2. The method as recited in claim 1, wherein the high-level menu display further comprises a top-level menu display.

3. The method as recited in claim 1, further comprising:
detecting local changes that occur on the client; and
updating the purchased content information on the client device to reflect the local changes.

4. The method as recited in claim 3, further comprising providing the updated purchased content information to the server when the client accesses the server.

5. The method as recited in claim 3, further comprising updating the high-level menu display with the local changes detected.

6. The method as recited in claim 1, wherein the purchased content information includes one or more of the following items: a program identifier; a program title; a program expiration time; a program expiration date; a program description; a program run time; a program rating; one or more program actors; one or more program producers; one or more program directors; a maximum number of time a program may be viewed; a program on-demand identifier.

7. The method as recited in claim 1, wherein the updating only occurs if the remote purchased content information has changed since the last time the purchased content information on the client has been updated.

8. The method as recited in claim 1, further comprising updating the high-level menu display if the updated purchased content information affects the displayed viewing parameters.

9. The method as recited in claim 1, wherein the client further comprises a set-top box and the display further comprises a television.

10. The method as recited in claim 1, wherein the purchased content further comprises video, audio and/or audio-video content.

11. The method as recited in claim 1, wherein the purchased content information includes a program expiration time associated with a purchased content program, the method further comprising providing a notification when the purchased content program cannot be concluded before the expiration time is reached.

12. The method as recited in claim 11, further comprising providing the notification when the purchased content program cannot be concluded when played at a normal speed.

13. A client device, comprising:
memory;
audio/video output means for transmitting audio and/or video data to one or more display devices;
a menu application configured to generate a top-level menu display associated with a content broadcasting system;
local purchased content information stored in the memory, the purchased content information including one or more viewing parameters and/or other data related to each of one or more purchased content programs;
means for accessing a content server; and
wherein the local purchased content information is updated from remote purchased content information stored at the content server whenever the content server is accessed for a purpose other than updating the local purchased content information.

14. The client device as recited in claim 13, further comprising an application configured to monitor the client device for local changes to purchased content and update the local purchased content information when any local changes that affect the local purchased content information occur.

15. The client device as recited in claim 13, wherein the local purchased content information is transmitted to the content server when the client device accesses the content server.

16. The client device as recited in claim 13, wherein the local changes further comprises one or more of the following: the playing of a purchased content program; the expiration of access privileges for a purchased content program; the cancellation of a purchased access program.

17. The client device as recited in claim 13, wherein the local purchased content information is updated only if the remote purchased content information has changed since the local purchased content information was previously updated.

18. The client device as recited in claim 13, wherein the local purchased content information further comprises one or more items from the following list of items: a program identifier; a program title; a program expiration time; a program expiration date; a program description; a program run time; a program rating; one or more program actors; one or more program producers; one or more program directors; a maximum number of time a program may be viewed; a program on-demand identifier.

19. The client device as recited in claim 13, wherein the top-level menu display further comprises a viewing parameters area to display current viewing parameters derived from the local purchased content information.

20. The client device as recited in claim 13, further comprising an application configured to detect a situation wherein access privileges for a purchased content program will expire before the purchased content program can be played to conclusion and top provide a notification of the situation.

21. A top-level menu display, comprising:
a purchased content display configured to identify one or more purchased content programs that have been purchased from a content provider and to display one or more viewing parameters for each purchased content program on a top-level menu display associated with the content provider; and
wherein the top-level menu display is updated with information retrieved from a content server when a client accesses the content server.

22. The top-level menu display as recited in claim 21, wherein the viewing parameters include one or more parameters from the following list of viewing parameters: a program identifier; a program title; a program expiration time; a program expiration date; a program description; a program run time; a program rating; one or more program actors; one or more program producers; one or more program directors; a maximum number of time a program may be viewed; a program on-demand identifier.

23. The top-level menu display as recited in claim 21, wherein:
a limited number or purchased content programs can be displayed at one time; and
the top-level menu display further comprises means to view all available purchased content programs.

24. The top-level menu display as recited in claim 23, wherein the means to view all available purchased content programs further comprises one or more scroll actuators.

25. The top-level menu display as recited in claim 23, wherein the means to view all available purchased content programs further comprises a scroll bar.

26. The top-level menu display as recited in claim 21, wherein the one or more viewing parameters further comprises an “on-demand” indicator to identify a video-on-demand purchased content program.

27. The top-level menu display as recited in claim 21, wherein the one or more viewing parameters further comprises a start date and a start time associated with a pay-per-view purchased content program.

28. One or more computer-readable media containing computer-executable instructions that, when executed by a computer, perform the following steps:
storing, on a client device, one or more program viewing parameters about one or more purchased content programs available in a content broadcasting system;
displaying one or more of the program viewing parameters on a top-level menu display associated with the content broadcasting system; and
updating the one or more program viewing parameters when the client device accesses a content server in the content broadcasting system.

29. The one or more computer-readable media as recited in claim 28, further comprising:
detecting one or more local changes in the client; and
updating the viewing parameters on the client device with information related to the local changes.

30. The one or more computer-readable media as recited in claim 28, wherein the viewing parameters further comprise one or more viewing parameters from the following list of viewing parameters: a program identifier; a program title; a program expiration time; a program expiration date; a program description; a program run time; a program rating; one or more program actors; one or more program producers; one or more program directors; a maximum number of time a program may be viewed; a program on-demand identifier.

31. The one or more computer-readable media as recited in claim 28, further comprising providing a user notification in the event that a user is watching a purchased content program that will not conclude prior to an expiration time associated with the purchased content program.
